(19) United States
(12) Patent Application Publication
(10) Pub. No.: US 2012/0189751 A1
(43) Pub. Date: Jul. 26, 2012

(54) Meat-Like Product and its Method of Production

(76) Inventors: Charles R. Beinecke, Pickerington, OH (US); Vicki L. McFarland, Reynoldsburg, OH (US)

(21) Appl. No.: 13/357,168

(22) Filed: Jan. 24, 2012

Related U.S. Application Data
(60) Provisional application No. 61/435,529, filed on Jan. 24, 2011.

(51) Int. Cl. A23L 1/0528; A23L 1/214; A23L 1/216

(52) U.S. Cl. 426/574; 426/508; 426/431; 426/436

(57) ABSTRACT

The invention is embodied in a low cost process for creating organoleptic meat analogs from unmodified potato starch and/or similar amylose/amylopectin containing tubers, roots and grains. The method involves thermo-irreversible gelatinization of starch, freeze-thawing, and incorporating extreme syneresis, to create starch gel nodules. Combining gel nodules with wheat gluten flour during the dough mixing formation of mass quantities of flavor absorbing, thin stranded, juicy, meat-like protein fibers. The product resulting from the method incorporates high quality plant protein, into a low carbohydrate, organoleptic juicy lean-meat analog.

### CROSS-REFERENCE TO RELATED APPLICATIONS

This application claims benefit of U.S. Provisional Application Ser. No. 61/435,529, filed on Jan. 24, 2011, the disclosure of which is expressly incorporated herein by reference.

### STATEMENT REGARDING FEDERALLY SPONSORED RESEARCH

Not applicable.

### BACKGROUND

The present disclosure generally relates to a novel process for utilization of syneresis in the creation of ecologically sustainable, plant-based meat analogs

This disclosure is in direct response to the below stated challenges to sustainability:
The greatest challenge to the planet and its populations, both animal and human, is an immediate future without availability of clean and abundant water.
The heavy dependence on fossil energy suggests that the US food system, whether meat-based or plant-based, is not sustainable.

This disclosure also is a direct response to the United Nations stated aim to tap into rice and “food of the future” potential of the potato. As populations grow, there is an increased demand for obtaining protein in the form of animal meats. It is well-known however, that meat consumption relies on the wide use of grains and vegetable matter as animal feed. The utilization of potential human foodstuffs as animal feed results in a dramatically reduced efficiency in the utilization of calories. Thus, if human consumption of vegetable matter could be increased relative to meat consumption, while satisfying the demand for meat products, energy consumption could be reduced and food availability increased.

Both rice and potato are primarily useful as sources of carbohydrates to provide calories. The carbohydrates of these crops are generally in the form of starch. Starch is an anhydroglucose polymer. Starch is a member of the polysaccharide group of polymers. It is laid down as insoluble, compact microscopic, semi-crystalline granules. One gram of starch typically contain something of the order of one billion granules. Within each granule, in turn, contains about 10 trillion starch molecules. Seeds, tubers, roots and stem piths are all repository sites for the starch. When digested, the trapped energy is released as the starch is broken down by hydrolysis back to its constituent glucose molecules and finally back to the original carbon dioxide and water.

Starch, as the principal energy reserve in plants, is one of the most abundant carbohydrates in the biosphere. Starch is a major source of nutrition for both man and animals. Its importance as a foodstuff may be judged by the fact that it accounts for over 30% of the average diet a dry weight basis for more than 25% on an available energy basis.

The presence of starch in the roots and tubers such as cassava and potato as well as in seeds and cereal grains contributes to the texture properties of some foods and as raw material in some industrial applications as thickener, stabilizer gelling agent and water holding agent. Storage starch, which is deposited in storage organs of starch crops, such as potatoes, serves as the most important energy source for human consumption. Due to the tissue structure of potatoes and the fact that starch is deposited loosely in the fruit water of the potato cells, the process of starch production is relatively simple.

Starch is a polymer composed of about one part of amylose and three parts of amylopectin, important to this disclosure's process of gelatinization. Typically crop roots and tubers comprise 16% to 24% starch and 4% lipids and proteins. The size of the granule varies depending on the starch source, the granules deriving from tubers being larger than those from cereals.

Despite the ubiquity of starch in nature, the number of commercially viable sources is small. The most common sources of starch are corn, potato, wheat, tapioca and rice. Regardless of extraction processes involved, the objective is to recover the insoluble starches as undamaged or intact granules. In this form it is known as native starch.

Genetically engineered alteration in starch composition generally leads to decreases in field production yields. The simple chemistry of starch does not reflect the extreme complexity of the final starch molecules structure in self-assembly processes of the resulting starch bi-polymers in the plant are not at all understood at the level that is required to predict the starch configurationally effects of a given genetic alteration.

It should be noted that any significant improvement, if only minor, of a starch crop will result in massive societal impact as a result of the huge volumes of starch consumed globally. It should however be borne in mind that deposition of starch, like all other biopolymers, is optimized for plant functionality and not for the consumers desires. Hence, structural alterations that impede the storage and remobilization functionalities will inevitably result in decreased crop production. Yield penalty decreases in starch content or crop production is linked to altered phenotypes.

More than half the U.S. grain and nearly 40 percent of world grain is being fed to livestock rather than being consumed directly by humans. Although grain production is increasing in total, the per capita supply has been decreasing for more than a decade. Clearly, there is reason for concern in the future. However, when this grain is, instead, fed to animals it takes between 50,000 to 100,000 liters of water to produce a kilogram of their meat.
To produce one kilogram of oven dry wheat grain, it takes 715-750 liters of water
For 1 kg maize, 540-630 liters
For 1 kg soybeans, 1650-2200 liters
For 1 kg paddy rice, 1550 liters
For 1 kg beef, 50,000-100,000 liters

About 124 kg of meat is eaten per American per year. Of the meat eaten, beef amounts to 44 kg, pork 31 kg, poultry 48 kg, and other meats 1 kg. Additional animal protein is obtained from the consumption of milk, eggs, and fish. For every 1 kg of high-quality animal protein produced, livestock are fed about 6 kg of plant protein. In the conversion of plant protein to animal protein, there are 2 principal inputs or costs: 1) the direct costs of production of the harvest animal, including its feed; and 2) the indirect costs for maintaining the breeding herds.

An estimated total of 3,265 pounds of agricultural products (including feed and grains) are produced annually to feed each American, while China's food supply averages only 1,029 pounds/capita/year. The world average value is 1,353 pounds/capita/year. The low number for China correlates with a vegetarian diet, the researchers point out, noting that most people in China eat essentially a vegetarian diet. The United Nations Food and Agriculture Organization (FAO) states that raising animals for food impacts global warming by generating more greenhouse gases than all the cars and trucks in the world combined.

Meat consumption is reaching an all-time high around the world, quadrupling in the last 50 years. There are 20 billion head of livestock taking up space on the Earth, more than triple the number of people. According to the Worldwatch Institute, global livestock population has increased 60 percent since 1961, and the number of fowl being raised for human dinner tables has nearly quadrupled in the same time period, from 4.2 billion to 15.7 billion. U.S. beef and pork consumption has tripled since 1970, during which time it has more than doubled in Asia.

Americans spend $110 billion a year on meat-intensive fast food, and its growing popularity around the world may be a factor in dramatic increases in global meat consumption.

One reason for the increase in meat consumption is the rise of fast-food restaurants as an American dietary staple. As Eric Schlosser noted in his best-selling book Fast Food Nation, “Americans now spend more money on fast food—$110 billion a year—than they do on higher education. They spend more on fast food than on movies, books, magazines, newspapers, videos and recorded music—combined.”

By 2050, beef will cease to be a “mass product” and could become “the caviar of the future,” he told a conference in Argentina. “The necessary resources for the production of beef will be three, four, five times higher than those of chicken and pork.” As a result, “beef will be what salmon was 50 years ago.”

The animal consumes nearly 1,300 kg of grains (wheat, oats, barley, corn, dry peas, soybean meal and other small grains), 7,200 kg of roughages (pasture, dry hay, silage and other roughages), 24 cubic meters of water for drinking and 7 cubic meters of water for servicing. This means that to produce one kilogram of boneless beef, we use about 6.5 kg of grain, 36 kg of roughages, and 155 liters of water (only for drinking and servicing). Producing the volume of feed requires about 15,300 liters of water on average. The water footprint of 1 kg of beef thus adds up to 15,500 liters of water. This still excludes the volume of polluted water that may result from leaching of fertilizers in the feed crop field or from surplus manure reaching the water system.

This disclosure contains the novel disruptive innovations and processes for producing an ecologically sustainable, primarily potato-based, ready-to-eat, highly palatable, protein-rich food, which can be instantly flavored for unlimited individual tastes.

It is the ultimate goal to create the food capacities that will produce and deliver at least 50 grams of protein-rich products, on a daily basis, to every mouth on the planet.

Like the world population, the US population continues to grow rapidly. The US population doubled in the past 60 years and is projected to double again in the next 70 years. The US food production system uses about 50% of the total US land area, approximately 80% of the fresh water, and 17% of the fossil energy used in the country.

Humanity has moved from using, in net terms, about one-half the planet's biocapacity in 1961 to over 1.2 times the biocapacity of the Earth in 2002. The global ecological deficit of 0.2 Earths is equal to the globe's ecological overshoot. Likewise, with water use increasing six-fold in the past century—more than twice the rate of Earth's population growth—demand for water is fast outstripping what the planet can replenish.

Worldwide, an estimated 2 billion people live primarily on a meat-based diet, while an estimated 4 billion live primarily on a plant-based diet. The shortages of cropland, fresh water, and energy resources require most of the 4 billion people to live on a plant-based diet. The World Health Organization recently reported that more than 3 billion people are malnourished. This is the largest number and proportion of malnourished people ever recorded in history. In large measure, the food shortage and malnourishment problem is primarily related to rapid population growth in the world plus the declining per capita availability of land, water, and energy resources.

Like the world population, the US population continues to grow rapidly. The US population doubled in the past 60 years and is projected to double again in the next 70 years. The US food production system uses about 50% of the total US land area, approximately 80% of the fresh water, and 17% of the fossil energy used in the country. The heavy dependence on fossil energy suggests, as first stated above, that the US food system, whether meat-based or plant-based, is not sustainable.

Industrial meat production is a heavy user of the planet's rapidly dwindling energy and water resources. It is for this reason that we believe the disruptive innovation of this disclosure contains simple to apply answers to the question of how to find, among the many forms of “industrial” meat replacements touted as greener or more environmentally friendly, the kind of meat replacements that really have a chance of pushing environmentally damaging, industrial meat off the table.

### BRIEF SUMMARY

A simple, water and energy conservative, low cost process for creating organoleptic meat analogs from unmodified potato starch and/or similar amylose/amylopectin containing tubers, roots and grains, that have been thermo-irreversibly gelatinized, freeze-thawed, and incorporating normally undesirable extreme syneresis, to create useful innumerable pressure sensitive water absorbing and emitting gel nodules, to be added easily to vital wheat gluten flour during the dough mixing formation of mass quantities of flavor absorbing, thin stranded, juicy, meat-like protein fibers, to be further enhanced by added freeze-thaw cycles.

Most promising is this disclosure's unique ability to process the entire meat analog product by using minimal water and readily available domestic and commercial freezing and cooking equipment, at standard atmospheric pressure and a fuel-efficient range (65 to 95° C.) of cooking temperatures.

This disclosure's unique process and methods relate primarily to a novel approach to creating, with readily available unmodified plant starches, flours and proteins, exceedingly generous production yields of organoleptic, fully cooked, juicy, lean meat-like-fiber analogs containing high quality plant protein.

Therefore, in keeping with all these above stated aims and issues, this novel disclosure creates up to 280% yields of unlimited varieties of high quality plant protein, low carbohydrate, organoleptic juicy lean-meat analogs, that are cholesterol-free, fat-free, soy-free, salt-free and sugar-free. Although oriented towards commercial production, the disclosure's novel processes may be achieved by anyone with basic cooking skills, using standard kitchen utensils and readily available cooking and freezing appliances. The disclosure's process incorporates thermo-irreversible gelatinization and freeze-thaw syneresis of amylose and amylopectin starches, from unmodified flours of tubers, roots and grains, along with minimal basic water, to generate up to 580% yields of “weeping gel nodules” to be easily and cleanly combined with ⅓ parts vital wheat gluten, thereafter to be simmered between 80° and 95° C., frozen and thawed, all of which creates juicy, lean-meat analogs, which may be further improved by added freeze-thaw cycles and the addition of unlimited regional and individually preferred flavors, by or for the ultimate consumer, instantly and with absolute ease, up to the point of consumption.

### BRIEF DESCRIPTION OF THE DRAWINGS

For a fuller understanding of the nature and advantages of the present assembly and components thereof, reference should be had to the following detailed description taken in connection with the accompanying drawings, in which:

FIG. 1 shows a general overview of the method disclosed;

FIG. 2 shows the temperature dependence of the gelatanization and retrogradazation process; and

FIG. 3 shows the progress of gelatinization, pasting and retrogradation processes of a number of starch sources.

### DETAILED DESCRIPTION

The invention of a vegetable based meat analog is embodied in a simple, water and energy conservative, low cost process for creating organoleptic meat analogs from unmodified potato starch and/or similar amylose/amylopectin containing tubers, roots and grains. The amylose/amylopectin containing structures are thermo-irreversibly gelatinized, freeze-thawed to create pressure sensitive water absorbing and emitting gel nodules, to which are added protein rich wheat gluten flour. Through a dough mixing, the formation of quantities of flavor absorbing, thin stranded, juicy, meat-like protein fibers are promoted, to be further enhanced by additional freeze-thaw cycles.

Most promising is this disclosure's unique ability to process the entire meat analog product by using minimal water and readily available domestic and commercial freezing and cooking equipment, at standard atmospheric pressure and a fuel-efficient range (65 to 95° C.) of cooking temperatures.

This disclosure's unique process and methods relate primarily to a novel approach to creating, with readily available unmodified plant starches, flours and proteins, exceedingly generous production yields of organoleptic, fully cooked, juicy, lean meat-like-fiber analogs containing high quality plant protein.

Therefore, in keeping with all these above stated aims and issues, this novel disclosure creates up to 280% yields of unlimited varieties of high quality plant protein, low carbohydrate, organoleptic juicy lean-meat analogs, that are cholesterol-free, fat-free, soy-free, salt-free and sugar-free. Although oriented towards commercial production, the disclosure's novel processes may be achieved by anyone with basic cooking skills, using standard kitchen utensils and readily available cooking and freezing appliances. The disclosure's process incorporates thermo-irreversible gelatinization and freeze-thaw syneresis of amylose and amylopectin starches, from unmodified flours of tubers, roots and grains, along with minimal basic water, to generate up to 580% yields of “weeping gel nodules” to be easily and cleanly combined with ⅓ parts vital wheat gluten, thereafter to be simmered between 80° and 95° C., frozen and thawed, all of which creates juicy, lean-meat analogs, which may be further improved by added freeze-thaw cycles and the addition of unlimited regional and individually preferred flavors, by or for the ultimate consumer, instantly and with absolute ease, up to the point of consumption.

It is generally stated, by those who are knowledgeable in the art, that high gelling capacity and freeze-thaw stability are a combination that is inherently difficult to achieve with existing natural unmodified starches. It is also widely accepted by those who are knowledgeable in the art, that by all reasonable means possible, syneresis of starches is to be avoided as an undesirable attack on the stability of any starch containing foods. However, contrary to those who wish to avoid syneresis, the system disclosed herein utilizes starch syneresis, as it relates to its freeze-thaw cycle gelled starch components, as being integral to this disclosure's further methods and processes for creating its meat analogs.

Basically, this disclosure begins by slow, low temperature, low shear cooking of its component ingredients of flours and water. These ingredient components are specifically and predominately made up of unmodified amylose and amylopectin starch bearing tubers (unmodified potato starch as the preferred predominant starch source), and/or roots and/or grains in approximately 10 to 30:1 parts of excess water. It is at generally between 60° to 80°, that gelatinization can occur, after which it is immediately removed from the heat source, chilled and frozen. Having then been gelatinized, and also crystallized, the resulting frozen gel is thawed so that it can enter retrogradation and subsequent syneresis in order to begin an unstable state of “weeping” of water from the thawed starch granules that have formed into innumerable gel nodules.

As stated, these freeze-thaw cycle's gelatinized starches are thus greatly encouraged to continue through synergisms to form innumerable individual gelatinized, retrograded nodules. These nodules are both water filled, and become very slippery mixing components for subsequent easy dough formation with otherwise extremely sticky vital wheat gluten flours that could not normally be processed without substantial waste and excessive clean-up with standard commercial production equipment and methods.

Syneresis characterizes the starch's stability to freezing and refrigeration. Starch with high amylose value influences gelatinization and retrograding properties. Starches with high amylose content, such as potato, present high syneresis due to the large amount of water expelled during the retrograding process. The low syneresis in starch paste is attributed to low amylose content and also to the possible aggregation of amylose crystallization occurring in the first storing hours whilst in amylopectin it would occur at later stages.

The granules of potato starches have high swelling power and consequent high viscosity. Said granules markedly swell when cooked in water and the swelling granules turn fragile due to mechanical shaking, resulting in instability during cooking. Unlike potatoes, other starches rich in amylose present granules with limited swelling due to the internal stiffness of strongly associated linear molecules, and the granules of the starches do not swell enough to form viscous paste when cooked in water under normal conditions.

The gelatinization temperature of potato follows the temperature range of 60° (initiation), 69° (peak formation) and 80° C. (maximum). Variations of gelatinization energy could present differences amongst the bonding forces of the amylopectin crystallography, which result in different alignments of the hydrogen bonds within the starch molecules.

The gel firmness is mainly caused by the starch gel retrograding, which is associated with the syneresis of water and amylopectin crystallization loss. Starches with high paste viscosity result in gels with high stiffness in cracking. Starch gels presenting high stiffness tend to have high amylose content and long amylopectin chains. In a particular potato starch variety it was found that there was high fracture ability and hardness, attributing this property to the presence of a high percentile of wide granules and low amylose content.

It should be noted that while the high amylose content results in irreversible recrystallization of the starch, amylopectin crystallization is reversible. The addition of only small amounts of salt dramatically decreases gelatinization viscosity. Additional lipids can have a profound effect on starch gelatinization by decreasing the gelatinization viscosity and slowing down retrogradation. Freeze-thaw stability requires high amylopectin concentrations and lower amylose concentrations. The increased gelling and retrogradation behavior of high amylose starch makes it ideal to achieve the gelled, short and chewy bite of gelled products.

### Starch Granule Water Gelation

More specific to this disclosure's process, these disclosed predominately potato-based starches are initially heated at 60° to 80° C., so as to accept 10 to 30 times their weight in excess water. They are immediately chilled and frozen, and then thawed and retrograded (generally after 24 hours), in order to begin severe syneresis, resulting in the formation of innumerable starch gel nodules. These nodules are further pressed to be drained to a level of 4:1 to 6:1 parts water for each part of original dry flour weight of combined amylose and amylopectin starch bearing tubers, and/or roots and/or grains.

Starch molecules comprise a number of hydroxyl groups that interact with water molecules, water being the usual medium for starch modification within the food industry. There is, consequently, a strong interaction (hydration) and affinity through hydrogen bonding between the high molecular weight starch storage molecules and the water molecule medium. Hydration of starch structures, brought about by cooking, produces an irreversible change of the structure of the starch granule whereby the starch—starch interactions are disrupted to be replaced by starch—water interactions. This interdigitation of water molecules forces the starch chains apart and the starch granule thus swells. Eventually the granule ruptures and starch polymers are dispersed in water medium producing a viscous colloidal state. The amount of available water during the hydration process is manage to control the structure and texture of the resultant food products. Gelatinization and pasting are respectively the technical description of the hydration within the granule and irreversible granule swelling that builds viscosity.

The hydrophilic nature of starch tends to promote the absorption of water by starch granules. The viscosity changes during hydration of the native starches are related to the structural transformations of swelling, rupture, dispersion and setback. During the initial stages of heating of starch in the presence of water, no viscosity changes occur at the molecular level within the granule. This absorption of water, which in the absence of detectable viscosity chains, is the first indication of gelatinization. At this stage the hydration and swelling are reversible. If cooled and dried at this juncture, sufficient molecular memory remains of the starch interactions within the granule to allow reversion to its original state. However, once the hydration has reached the critical pasting stage, a rapid onset in the development of viscosity is seen. At this point the structural changes of the granule are irreversible. With continued heating the paste viscosity climbs to a peak. Overcooking then decreases viscosity as the granules rupture. On cooling, retrogradation and gel formation occur quickly. Potato starch exhibits the greatest relative swelling during gelation, compared to other starchy vegetable matter, due to its large granules size. In this case the very rapid viscosity development at low temperature is due to the presence of naturally occurring phosphate groups, which are responsible for starch—starch repulsion thereby weakening the granule and accelerating its rupture during cooking. For native starches, the process tolerance is extremely fragile and, in general, native starches suffer from over cooking. The vegetable

### Protein Fiber Development to Create Meat Texture

The development of meat-like fiber structure is a crucial step in the disclosed process. Following gelation, freeze-thaw cycling, and pressing, 2 parts of a tempered pressed vegetable product (comprising 4:1 to 6:1 water-content freeze-thawed and drained gelatinized starch gel nodules) are combined with approximately 1 part of vital wheat gluten flour. This combination typically occurs as part of a standard mixing operation, wherein the mixer paddle is activated at a low speed to allow modest surface water from each water-filled starch granule to come into immediate but limited surface contact with the added hydrophilic vital wheat gluten flour. The initial mixing is at a low speed/low shear rate, such that the mixing action does not encourage additional water to be pushed out of the nodules (and into the wheat gluten flour) until a dough begins to form. Additional subsequent mixing causes the individual water-filled starch granule nodules to further extract water from the nodules and into the gluten flour, thereby causing the dough to form many groups of nodules with thin layers of vital wheat gluten protein, thereby allowing the protein fibers to from the gluten flour be stretched thinly around water emitting starch granule nodules instead of just clumping into dense rubbery gluten flour masses. Typically, clumping occurs when attempting to mix wet flours with wet vital wheat gluten flour.

Therefore, this disclosure provides a process for creating post syneresis slippery starch nodules with internal water-bearing-emitting granules. These nodules in turn provide localized supports for formations of much desirable thin layer stretched protein fibers arising from wheat gluten. Further combining of these thin layers of stretched protein fibers with a standard dough roller into a cohesive fibrous dough is again made easier because the water from the internal water-bearing-granule nodules are still somewhat limited to their specific spheres of vital wheat gluten influence by the encapsulation by the wheat gluten. The gluten encapsulated starchy nodules are restricted to associate with only the most proximate vital wheat gluten encapsulated nodules, thereby encouraging additional stretching of each small vital wheat gluten encapsulated nodule into longer, thin, meat like fibers. These fibers ultimately join with other individual fibers into a form of thinly stranded but completely connected meat-like structures. These structures are vegetable matter meat analogs of skeletal muscle, such as found in the hindquarters of mammalian livestock.

This disclosed process to enhance the limited water emission into specific proximate areas of vital wheat gluten, only at the point of mixing and stretching, serves to avoid most, if not all, post-mixing cleaning generally associated with the typically sticky combinations of generally wetted vital wheat gluten flour combined with matter from other wetted tuber, and/or root and/or grain flours.

The meat analog product formed according to the present disclosure has a nutritional value comparable to that of meat. Table I shows the nutritional value of the meat analog (pre-flavored) per each serving size of 2 ounces (56.7 g)

TABLE I
Nutrition Facts
Serving Size: 2 oz (56.7 g)
Amount Per Serving

| Calories 80 | | % Daily Value* | | | |
|---|---|---|---|---|---|
| | Calories | 2,000 | | 2,000 | |
| Total Fat | Less than | 65 | g | 80 | g |
| Saturated Fat | Less than | 20 | m | 25 | g |
| Cholesterol | Less than | 300 | mg | 300 | mg |
| Sodium | Less than | 2,400 | mg | 2,400 | mg |
| Total Carbohydrate | | 300 | g | 375 | g |
| Dietary Fiber | | 25 | g | 30 | g |

### Method of Producing Meat Analog

This disclosure's novel process creates meat analog artisan roasts that are initially flavor-neutral and remarkably lacking in any rancid after-taste normally associated with highly heated fats that can be related to the processing of naturally occurring lipids in basic grains and vital wheat gluten flours. Although pleasantly neutral, it can easily benefit from post-cooking additions of an infinite array of flavorings, marinades, brines and coatings, effectively even up to the point of being consumed.

The disclosure's objectives are primarily obtained by the following process steps, generally, as follows:
a) Combine unmodified tuber, root and grain starches and flours with approximately 10 to 30 times their dry weight in water;
b) Cook these starches and flours at up to 80° C. for gelatinization;
c) Subsequently chill and freeze these cooked starches and flours;
d) Thaw gel;
e) Reduce excess water by draining thawed gel so that remaining gel contains 4 to 6 times its original dry weight of flours and starches in water weight;
f) The resulting thawed and drained gel may thereafter be dyed or left natural;
g) Each part of the resulting thawed and drained gel may be easily combined with approximately 3 to 5 parts of 80% protein containing vital wheat gluten flour, into a cohesive, well kneaded and roller stretched meat-like fibrous dough.
h) The meat-like fibrous dough roasts are thereafter simmered at up to 100 degrees Celsius, in plain or dye-containing water, for up to 2 hours.
   The resulting product generates yields of up to 280% total mass relative to the dry weight of incorporated starches and flours. Meat-analog roasts created according to this method generally provide yields exceeding 11 parts of 20% protein containing lean-meat analogs for each 1 part of starch bearing tubers, and/or roots and/or grain flours. Each meat-analog roast will generally contain less than 40 calories and under 3% carbohydrates per cooked ounce. Other than those lipids naturally occurring in tubers, roots and grains, there are no additions of any oils or fats and is, therefore, cholesterol-free. The product is also free from any added sugar, soy and salt.

The disclosed method does not create fat-like gels previously created for the following reasons: a lean meat-like artisan roast is desired, which desire is contrary to those who are skilled in the art of partial replacement of fat by using starches to create stable thermo-irreversible gels that appear as soft fat after chilling only; soft fat-like gels generally require starch granule rupture in volatilization for functionality, such rupture being in direct contrast to the present method's development of normal, viscosifying starches that require intact, swollen starch granules for maximum syneresis after freeze-thaw.

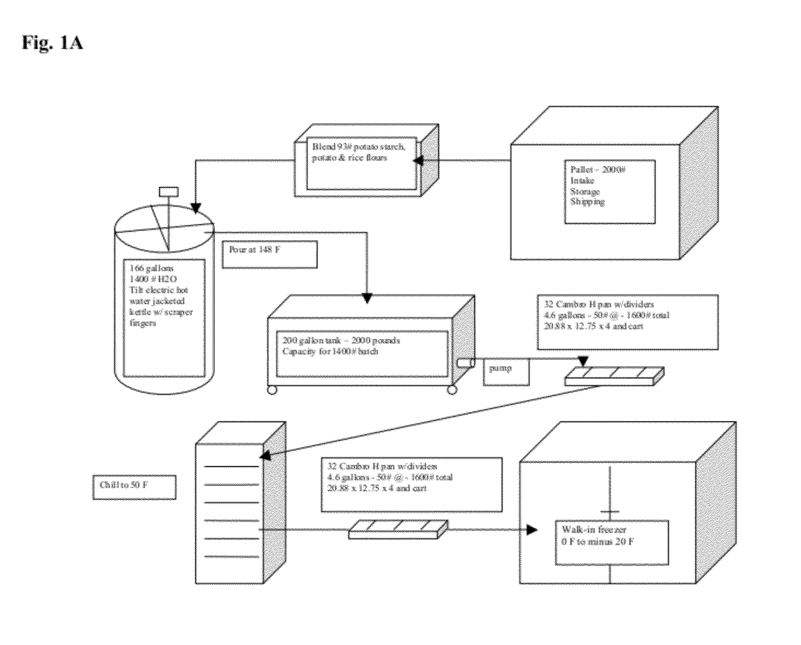

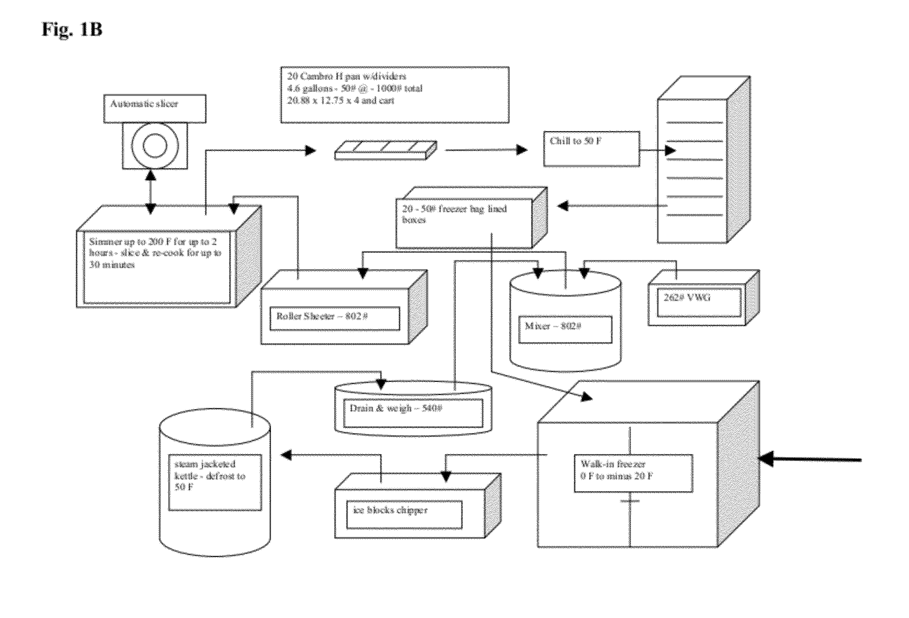

The process flow of the present disclosure is shown in FIG. 1.

This disclosure prefers reverse-osmosis filtered water but it has not yet been determined how other sources of water will affect its process, ingredients and final products. It is possible that various differences in water supply may affect the product. In particular sediment and chlorine may interfere with or instill unwanted flavors in the final product.

Starch Sources for Use with Method.

This disclosed method does not require any specially engineered or biochemically processed starches for successful creation of meat analogs. A preferred feedstock is simple unmodified potato starch. Therefore, this disclosure does not include disclosure of the modification of starches by way of enzymatic processing or genetically engineered changes. The disclosed method does not require chemical modification of a starch as has been generally used to improve paste stability, paste clarity, texture; mouth-feel and smoothness of consistency along with reduced syneresis, and freeze-thaw stability.

Food scientists have searched for physical modification techniques of starch that do not require the chemical modification presently in use. Prior to the present disclosure, there have been only limited economically viable alternatives to chemical starch modification to meet the many requirements of food processing. The present disclosure involves primarily physical rather than chemical modification.

Contrary to this disclosure's processes, cross-linking is considered by those who are skilled in the art as the most important chemical modification to the starch industry and involves a replacement of hydrogen bonding between starch chains by stronger more permanent covalent bonds that allow it to become resistant to gelatinization that occurs in the parent native starches.

Also, contrary to this disclosure's processes, covalent stabilization is also considered by those who are skilled in the art as the starch industry's second-most important modification and is usually used in conjunction with cross-linking under the primary objective of stabilization in order to prevent retrogradation and thereby enhance shelf life through tolerance to temperature fluctuations such as freeze-thaw cycles.

This disclosure's use of simple unmodified potato starch is also in direct contrast to those who are skilled in the art who believe that unprocessed native starches are generally structurally too weak and functionally too restricted for application of most of advanced technologies. Contrary to this disclosure's processes and methods, they also subscribe to the notion that starch modifications, both chemical and biochemical, are an appropriate means of altering the structure and affecting the high bonding in a controllable manner to enhance and extend their application.

Though amylose is not the major component in most granules, it has a large influence on the properties of starch. The amylose content a most starches is 20 to 30%. Potato has a general amylose content of 20%. Different potato varieties have gelling power for their starch granules at 90° C. of 36.5 g to 40.5 g per gram of starch. Starches such as amylose show high swelling power and low solubility when heated in excess water. The crystalline molecular structure of starch is broken and the water molecules are bonded to the free hydroxyl groups of amylose and amylopectin by hydrogen bonds, which could cause an increment in the absorption capacity and solubility.

Amylose structurally is a linear polymer of anhydroglucose units, of molecular weight approximately between 40,000 and 340,000, with chains containing 250 to 2000 anhydroglucose units. Amylose contributes to the jelling property of starch just as amylopectin contributes high viscosity. This classic statement, however, may not be entirely valid. Both properties are used in the preparation of food.

Part of the problem of understanding the role of amylose is a basic question why nature has evolved to produce two such similar polysaccharides (amylose and amylopectin) within the same granule. Starch granules are rarely consumed as intact granules. Processing can take many forms: milling, enzymatic degradation, cooking, extrusion and chemical modification. This disclosure, however, limits itself primarily to the natural effects of milling and cooking.

Milling can lead to substantial damage of the granules. Damage leads to a greater degree of water absorption and a consequent increase in the amount of swelling which occurs in water. Severe milling also reduces the crystallinity. This is consistent with a substantial decrease in chain length for potato starch. This granule disruption will make gelatinization easier. Damaged starch is also more susceptible to the enzyme that is naturally occurring in human saliva. An important issue surrounds those starches, which are known to be more resistant to digestion and whose presence may confer health benefits. Thus, in vivo as well as in vitro mill damage of granules leading to rapid amylolysis may have significant impact on functionality and properties of starch.

The separation of amylose from amylopectin without degradation of either polymer has been a difficult undertaking. Currently, high amylose and high amylopectin waxy starches are manufactured from mutant varieties of grain—which runs contrary to the unmodified starch sources utilized by this disclosure.

There are essentially three parameters to consider for this disclosure's process, namely, time, temperature and shear during manufacturing and reconstitution. These parameters should not be viewed in isolation since, in most processed food at least two of the parameters are involved. In general, higher temperature, longer hold time and greater shear forces will promote granule swelling and, consequently, the starch will be more susceptible to rupture and breakdown. This disclosure eschews developing any tolerance to such processing factors as achieved by strengthening the granule through cross-linking or thermal treatment. Table II lists a variety of factors contributing to disruption of starch granules.

TABLE II

| Equipment | Time | Temperature | Shear | Pressure |
|---|---|---|---|---|
| Steam jacketed kettle | Long | Low-medium | Low | |
| Plate heat exchanger | Short | Medium-high | High | |
| Scraped-surface heat exchanger | Short | Medium-high | High | |
| Jet cookers | Short | Medium-high | Medium-high | |
| Direct steam injection cookers | Short | High | Very high | |
| Retorts | Very short | High | High | Low-medium |
| Extruder cookers | Long | High | Low | High |
| Flash cooling | Short | High | High | High |
| Piston pump | | | High | |
| Mono pump | | | Low-moderate | |
| Centrifugal pump | | | Moderate | |
| Colloid mill, homogenisers | | | Moderate-high | Low-high |
| Microwave | | | Very high | |

* High temperature, shear and pressure are often referred to as “high stress” processes. For such environments, specific modified starches will be required.

Starch in this disclosure's ingredients is much more shear stable at ambient or cool temperatures as compared to elevated temperatures. Studies have shown that below 57.2° C. starch solutions can be processed with little shear damage. Starch in solution prior to gelatinization is very shear stable.

Table 13.2 list a variety of factors contributing to the stabilization of viscosity.

TABLE 13.2
Consider the impact of processing conditions on viscosity stability

| Equipment | Time | Degree of shear |
|---|---|---|
| Kettle | long | low |
| Swept surface | intermediate | moderate-high |
| Plate heat exchanger | short | high |
| Jet cooker | | |
| low back pressure | short | low |
| high back pressure | short | high |
| PDP_{Positive Displacement Pump} | short | low |
| Centrifugal pump | short | high |
| Piping | variable | variable |
| Emulsification | | |
| Colloid mill | short | high |
| Homogenization | very short | very high |

All foods, particularly those containing unmodified starches, are affected by the type of freezing system used, as well as how long the product is going to be subjected to continuous freezing. This disclosure's freezer stages of processing actually exploits what the industry considers as negative affects of freezing. The use of rapid or blast freezing reduces ice crystal size. However it is handled it can still be a thermal shock to the starch granule, food particulates or other temperature sensitive components. The use of spiral freezers that are significantly slower is more common and generally creates larger ice crystals. Within the freezing process the slower the water freezes, the greater the chance for large ice crystal build-up. This can normally be detrimental to added starch, but is not so for this disclosure's products. Ice crystals can cause the fragmentation of granules and/or food particulate cell walls, which is not necessarily a problem for this disclosure's products. Dependent upon the storage conditions, ice crystals can continue to grow, thus increasing storage or product degradation and shortening the overall shelf-life of the food product which is not necessarily a problem for this disclosure's products. One positive attribute for freezing, regardless of method, is that freezing retards bacterial and enzyme activity.

Although not currently utilized by this disclosure, when extended shelf-life is desired (greater than a year), industrial studies have shown that starch blended with small amounts of a gum (hydrocolloid) maintain a higher product quality than starch alone. For foods that are to be frozen (−20° to −40° C.), it is suggested that a minimum of 1.5% of a properly modified starch and approximately 0.025% of gum (xanthan) be used (formula weight).

### Starch Gelatinization Process

This disclosure's starch goes through gelatinization and retrogradation and these processes result in RS3 Resistant Starch.

Starch gelatinization is a process that breaks down the intermolecular bonds of starch molecules in the presence of water and heat, allowing the hydrogen bonding sites (the hydroxyl hydrogen and oxygen) to engage more water. This irreversibly dissolves the starch granule. Penetration of water increases randomness in the general granule structure and decreases the number and size of crystalline regions. Crystalline regions do not allow water entry. Heat causes such regions to be diffused, so that the chains begin to separate into an amorphous form. Under the microscope in polarized light starch lose its birefringence (double refraction is the decomposition of a ray of light and other electromagnetic radiation into two rays—the ordinary ray and the extraordinary ray—when it passes through certain types of material), its extinction cross (optical phenomenon that is seen when trying to extinguish a laser beam or non-planar white light using crossed polarizers). This process is used in cooking to make roux sauce, pastry, custard or popcorn.

Gelatinization is also known as the thickening of a liquid. During this process the starch grains/flour granules absorb the liquid. When heated the grains/granules swell and then burst, releasing starch into the liquid. The granules/grains swell to 30 times their original size (i.e. swelling power, peak viscosity).

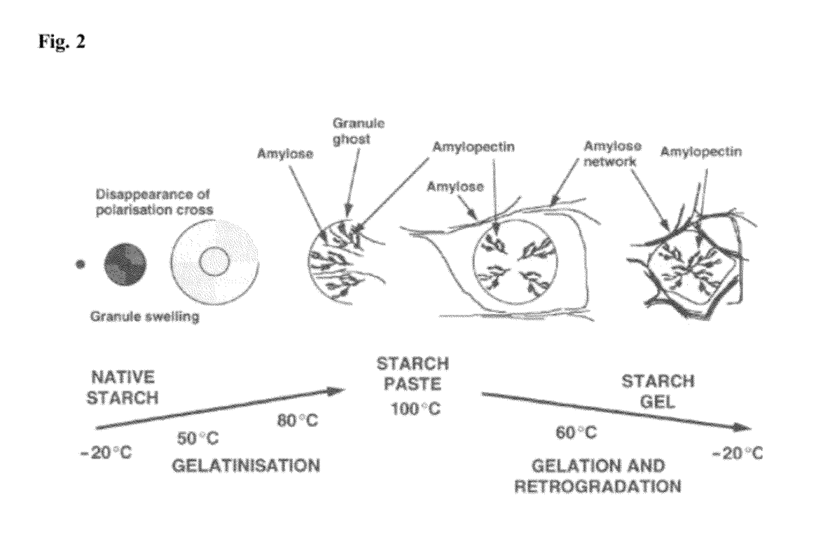

Prolonged heating and/or pressure and stirring are needed to completely dissolve the remaining fragments of starch granules. During prolonged heating, the viscosity will reduce, and the rheology-texture of the solution will change. FIG. 2 shows the temperature dependence of the gelatanization and retrogradazation process.

In contrast to the well known stiff gels of cereal starches, this disclosure's preferred potato starch gels are characterized in general by a stringy and slimy texture—which is naturally ideal for this disclosure's processes. Basic to forming this disclosure's dough is the development of a thermo-irreversible potato starch gel, made by a method generally described below as one of many possible alternative combinations:
1. First, a potato starch and flour and rice flour mix is made by combining 13 parts (w/w) of unmodified potato starch with 6 parts of white rice flour and 1 part of potato flour.
2. A slurry is then made up of these dry ingredients at a ratio of 1 part dry mix combined with 15 parts of 50 degree Celsius tap water to be placed in an agitation jacketed heating/cooling kettle.
3. Sufficient continuous agitation is then provided to keep starch in uniform suspension (slurry).
4. The slurry is then heated under agitation to a temperature of 65° C. for about 5 seconds to achieve a 95%-100% gelation.
5. This starch gel is then quickly poured and chilled in a refrigerated holding container to about 10° C.
6. The gel is subsequently placed in a freezer to be frozen to a temperature of about minus 20° C. for 24 hours until ready for thawing, draining and inclusion in the dough forming application part of this disclosure's process.

Starch granules that are fully gelatinized are easily digestible. The degree of gelatinization can be influenced by the water content of the product, the temperature, the duration of heating and the pressure (Bjorck et al., 1994). During cooling and aging of gelatinized starch recrystallization occurs; this is termed retrogradation and is not easily digested, hence the term “resistant starch” is applied to it. Extensive university and medical research on resistant starch appears to point to the potential for good health prospects and is a preferred by-product result of the disclosure process.

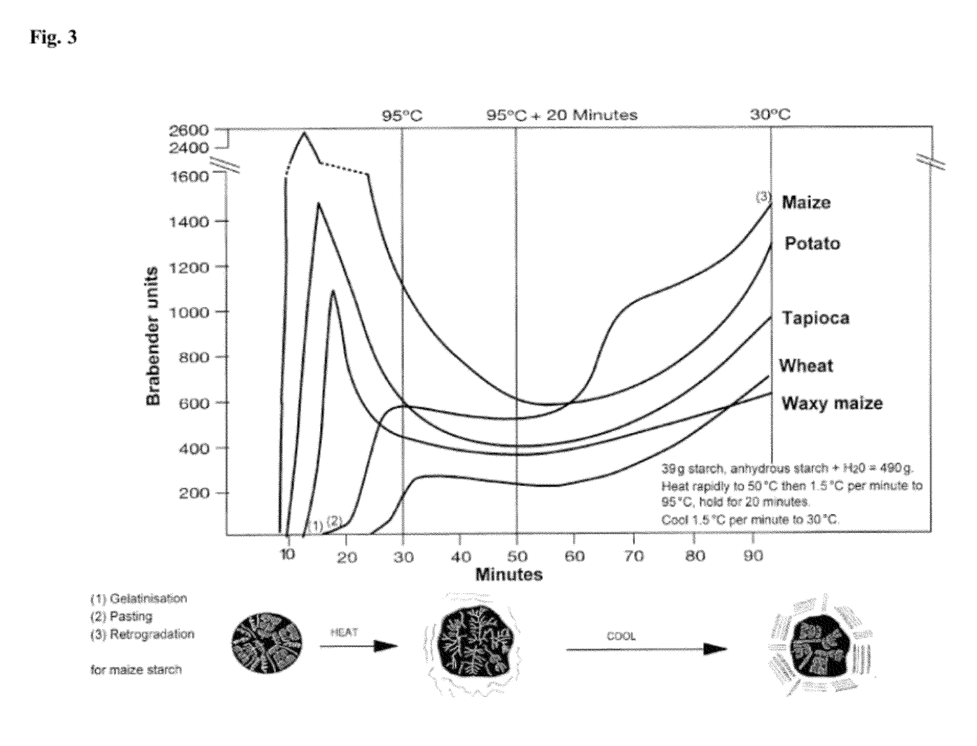

FIG. 3 shows the progress of gelatinization, pasting and retrogradation processes of a number of starch sources. When starch is heated with water, insoluble granules are disrupted by the energy supplied, resulting in a loss of the molecular organization responsible for the crystallinity and the penetration of water. Swelling of the granules results in increased viscosity and a complete loss of crystallinity. The temperature at which birefringence is first lost is called the gelatinization temperature. The increase in viscosity continues to a maximum as most granules burst to form a network of interlocking chains. Upon cooling, the amylose chains zipper together and, aided by the amylopectin, form a gel, provided the concentration is high enough. This process is referred to as gelation. The starch gel occurs when swollen starch granules reinforce an intimate amylose gel matrix. High water to starch ratios allows birefringence to occur at a lower temperature than lower water starch ratios.

The combination of viscous and elastic behavior is termed viscoelasticity. The gel forming properties of amylose allow shear thinning while heating, and a sharp increase in elastic modulus after cooling.

The gel forming ability of starch is due to the amylose component. This is because of amylose forms extensive hydrogen bonding (H-bonding) networks with water molecules, as well as intramolecular H-bonding.

Amylopectin is more readily soluble in water than amylose and occurs only at concentrations greater than 10% (W/W) or when amylopectin chains become heavily entangled, especially after storage at 1° C. Crystallization of amylopectin is largely reversible unlike that with amylose. Amylopectin contributes more significantly to the viscous modulus in starch while amylose contributes more significantly to the elastic modulus.

Amylopectin undergoes retrogradation more slowly and to a much lesser extent than amylose, because it has a highly branched structure. Unlike the linear amylose, amylopectin molecules are not able to ally with H-bonds so readily; this only happens over limited regions.

Although not utilized in this disclosure, a native starch can be gelatinized prior to use, making it possible to be used in products that do not require cooking. This type of starch, called pregelatinized starch, is very useful for instant desserts and baby foods. Pregelatinized starch is manufactured by feeding an aqueous starch slurry on to steam-heated rollers. The gelled starch is removed, by a scraper, crushed and sieved.

The property profile of potato starch is generally superior to other industrially produced starch types, not only with the viscosity behavior of its paste being outstanding but also other characteristics like granule size/granule size distribution, the concentration of protein, lipids and minerals and phosphorus concentration. However, the indicated property profile depends greatly on the genetic basis of the potatoes for which the starch has been extracted. Additionally, growing conditions, fertilization as well as any environmental conditions also contribute to the formation of many aspects of the starch's property profile. Native potato starches compare well against competing cereal starches.

The high level of purity, in particular of lipids, grants potato starch a neutral taste and prevents it from developing off-flavors under conditions of long-term storage. When heated in aqueous suspension, potato starch loses irreversibly its granular structure as it reaches a critical temperature range, the so-called gelatinization temperature. Under such conditions granules swell tangentially at first and disintegrate under formation of a colloidal dispersion. For potato starch a temperature range reaching from 56 to 66° C. has been reported in the disintegration process. The disintegration is connected with a sharp increase in viscosity, which is usually pronounced with potato starch as a result of the additional hydration of the characteristic phosphate ester groups. Furthermore, cations connected with water starch bind water in their typical way and withdraw water needed for hydration of starch molecules thus contributing to further viscosity. In this rise of viscosity following gelatinization, a peak maximum is reached during or after heating to 95° C. This is followed by a sharp and very pronounced breakdown for the potato starch as a result of the sheer forces applied by mixing elements at high temperature. The following cooling phase allows potato starch paste to settle again and gels form a so-called setback.

Dispersed starch systems tend to change their state of order while at the same time releasing bound water. The visible effect is called syneresis and can be understood as an indication of intensive changes in gel structures. In direct contrast to this disclosure's desire to utilize syneresis, for those who are skilled in the art of food preparation such changes are highly undesirable, especially in products that require freeze-thaw stability.

Starch is usually eaten after an initial gelatinization step. Dramatic changes occur in the structure of the starch granule when it is heated in the presence of water. The first change is loss of the polarization cross. As temperature increases, hydrogen bonds between starch chains are disrupted and water is absorbed by the starch granule. This swelling is followed by a step of amylose leaching. The starch is progressively dissolved, gradually increasing the viscosity of the solution. The gelatinization step leads to the formation of a starch paste. This state of utmost disorganization is a function of the gelatinization temperature, which varies according to the starch origin and depends on the amylose/amylopectin ratio. Amylose content is not a discriminant indicator of amylase susceptibility when starch is native (Bornet et al, 1989). Tuber starches are highly resistant to a-amylase despite their low amylose content. However, after gelatinization, amylose content becomes an important factor in determining amylase susceptibility. It is explained by the marked tendency of high amylose content starch to produce hard gels, retrograded amylose and amylo-lipid complexes. In the meantime, an inverse relationship appears between amylose content and the degree of glycaemic response to processed starchy food (Bornet et al, 1989, Goddard et al, 1984, Granfeldt et al, 1995).

### Retrogradation Processing

Retrogradation is a reaction that takes place in gelatinized starch when the amylose and amylopectin chains realign themselves, causing the liquid to gel.

Retrograded starch is less digestible and, as such, has been linked to a reduction in colon cancer, which is very much a desired, although yet to be proven, outcome of this disclosure.

When native starch is heated and dissolves in water, the crystalline structure of amylose and amylopectin molecules are lost and they hydrate to form a viscous solution. If the viscous solution is cooled or left at lower temperature for long enough period, the linear molecules, amylose, and linear parts of amylopectin molecules retrograde and rearrange themselves again to a more crystalline structure. The linear chains place themselves parallel and form hydrogen bridges. In viscous solutions the viscosity increases to form a gel. At temperatures between −8° and +8° C. the aging process is enhanced drastically.

As temperature decreases, a gel forms progressively under the action of the system and consists of the remaining wrapping of the starch granules (ghost particles) enriched in amylopectin, following immersion in a high amylose content; this is called the elification step. A rearrangement between starch chains occurs and a three-dimensional network is rapidly constituted. The higher the amylose content of starch, the harder the starch gel. The starch gel structure has lower a-amylase susceptibility than a paste. As starch chains rearrange, hydrogen bonds between chains reappear and a novel crystalline structure is created; this is referred to as the retrograded phenomenon. Over time, starch gel retrogradation increases. It is all the more marked if the gelatinization of the starch has been conducted well, i.e., at high temperature, with high moisture and under prolonged and effective stirring. The other factors that promote retrogradation are high amylose content, low starch gel moisture and low storage temperature (4° C.). Retrogradation is delayed when mono- or triglycerides are added, whereas all the factors preventing dehydration of starch gel encourage its retrogradation. The crystalline structure of retrograded amylose is acid and heat-resistant. Its melting-point is above 120° C. In vitro, the retrograded starch and retrograded amylose fractions are highly resistant to a-amylase. This resistant starch fraction is resistant to amylase digestion in the human digestive tract and exhibits digestive behavior similar to that of the non-starchy polysaccharide fraction (NSP) or indigestible oligosaccharides.

Retrogradation can expel water from the polymer network. This is a process known as syneresis. A small amount of water can be seen on top of the gel. Retrogradation is directly related to the staling or aging of bread.

Retrogradation also means the return from a solvated dispersed state to an insoluble aggregate state. The change is accompanied by an increasing cloudiness as well as formation of free water, the latter being termed syneresis—which is also naturally most ideal for this disclosure's processes.

Starch degradation, in vitro, owing to amylolytic enzymes, also varies depending on the starch's gelatinization origin and vegetable issues. The susceptibility to the enzymatic attack is influenced by factors such as the amylose:amylopectin ratio, the crystalline structure, the particle size and the presence of enzymatic inhibitors.

The starches major physical-chemical and functional properties for feeding are gelatinization retrogradation, solubility water absorption power, syneresis and their rheological behavior in pastes and gels. These physical and functional properties are influenced by the shape, molecular structure and botanical source of native starches in the different vegetable sources.

### Resistant Starch Processes

Resistant starch (RS) is starch and starch degradation products that escape digestion in the small intestine of healthy individuals. Resistant starch is considered the third type of dietary fiber, as it can deliver some of the benefits of insoluble fiber and some of the benefits of soluble fiber.

Some carbohydrates, such as sugars and most starch, are rapidly digested and absorbed as glucose into the body through the small intestine and subsequently used for short-term energy needs or stored. Resistant starch, on the other hand, resists digestion and passes through to the large intestine where it acts like dietary fiber.

Resistant starch has been categorized into four types:
RS1 Physically inaccessible or digestible resistant starch, such as that found in seeds or legumes and unprocessed whole grains
RS2 Resistant starch that occurs in its natural granular form, such as uncooked potato, green banana flour and high amylose corn
RS3 Resistant starch that is formed when starch-containing foods are cooked and cooled such as in legumes,^{[2]} bread, cornflakes and cooked-and-chilled potatoes or retrograded high amylose corn
RS4 Starches that have been chemically modified to resist digestion. This type of resistant starches can have a wide variety of structures and are not found in nature.
The starch produced as disclosed herein likened to RS3—produced strictly through the addition of starch to excess water, heating to 65° C., and then immediately freezing.

There is some discussion about resistant dextrins being described as “resistant starch”. Resistant dextrins are not starches, and they can be soluble or insoluble. They might be described as “starch degradation products”, which is literally included in the EURESTA definition, but their characteristics and performance are very different than insoluble resistant starches.

An additional benefit of this disclosure's resistant starch is that ongoing research seems to promise the promotion of good health as related to resistant starch as well as the option to form denatured proteins and their digestive benefits.

In modern societies, great emphasis is frequently placed on the relationship between health, lifestyle and diet. With major infectious disease under control, focus has shifted from reactive cure to proactive prevention. Given the nutritional connotation that ‘you are what you eat’, there is much debate surrounding food fortification.

The effect of added soluble viscous dietary fibers on the reduction of both glycaemic and insulinaemic responses has been largely reported. Some effects of insoluble fibers and dietary resistant starch on short-term post-prandial glycaemia have been also reported, but the effect is weaker. The lowering effect of resistant starch on blood glucose (by replacing rapidly the digestible starch fraction) has also been underlined.

Resistant starch (RS), has a role to play with regard to the nutritional benefits of fiber fortification; it occurs naturally in many unprocessed foods such as whole grains and is now available commercially in concentrated, process-tolerant formats. RS goes under many definitions but, in essence, it is starch that is resistant to digestion in the stomach and small intestine. RS offers advantages over cellulosic sources of fiber such as bran. It provides low water-holding capacity thereby aiding processing; it enhances the organoleptic qualities of food as a replacement for, or complement to, natural fiber and in the UK it can be labeled as ‘dietary fiber’. Although research in this area is still in its infancy, there are potential physiological benefits in relation to the biochemistry of the colon and glucose/insulin metabolism. In the former, it is said that ‘desirable’ microflora are encouraged in the gut from the prebiotic action of RS leading to improved colonic health. In the latter, it offers a controlled rate of digestion to glucose without the peaks and troughs produced by highly-processed carbohydrates.

Of the four types of resistant starch, RS II, III and IV are commercially available. RS I is the physically inaccessible starch found in grain, seeds and legumes. In general, it is not suitable as a food ingredient since processing can destroy it. RS II is a granular starch which, in an uncooked state, is naturally resistant to enzyme attack. It is found in green bananas, potatoes and very high amylose starch. RS III and IV are formed through: thermal modification, e.g., as in bread crusts, cornflakes or retrograded high amylose starch; or chemical modification, e.g., as in repolymerization to alter the glycosidic linkages such that they are no longer recognized as amylose.

Commercial sources of RS assay at 30±60% dietary fiber (as measured by the Prosky AOAC method). Assuming 50% of the RS product is indigestible (i.e. reaches the colon) then for labeling purposes it can be considered as non-calorific and has a theoretical calorific value of only 1.9 kCal/g. This makes resistant starch products ideal ingredients for the fiber fortification of low-calorie products. Note: that as material reaching the colon provides energy to the body the actual physiological calorific is likely to be closer to 2.8 kCal/g. Processing of high-fiber products has traditionally been fraught with problems related to the high water-binding capacity of cellulosic fibers. RS offers processing advantages, not only due to its low water-binding capacity but also due to a negligible impact on dough viscosity and rheology, since it does not compete for water. There is even a textural benefit observed with RS in low-moisture systems where, for example, cereals and snacks containing RS are more expanded and retain a light, crispy texture. This is in contrast to the texture attributed to oat bran-substituted snacks and cereals which are dense and hard, and accordingly have a reputation of limited palatability. However, a synergistic action of RS complementing traditional cellulosic fibers can dispel this reputation and open up opportunities for dietary enhancement with texturally appetizing and nutritionally balanced foods.

The glucose polymers that make up starch come in to molecular forms, linear and branched. The former is referred to as amylose and the latter as amylopectin. Amylose is considered to be linear with only a small degree of branching whereas amylopectin contains multiples of branching that allows it to weigh as much as 1000 times that of amylose.

The normal starch granule contains about 25% of the polysaccharide as amylose with the rest as amylopectin. Amylose may be the precursor for amylopectin by providing a lesser branched or unbranched amylase-like intermediate. Branching enzymes interact somehow to produce two carbohydrates—amylose and amylopectin—to form starch granules during light photosynthesis. However, whether potato tubers have two isoforms of branching enzymes isolated from potato tubers has not been determined.

In vivo, starch synthesis occurs by deposition on the granule surface by the concerted action of starch synthases and branching enzyme. We can have granule-bound forms and soluble forms and yet it has not been possible, so far, to find out how the enzymes interact to produce the two carbohydrates, amylose and amylopectin, that form the starch granules.

The amylose structure is also of the smaller molecular size. Starch content and potato tuber range is between 65 and 90% of the total dry matter. Potato starch has a fibrillar organization to it. Two polymers are distinguished in the starch granule amylose, which is essentially linear, and amylopectin, which is highly branched. Amylopectin usually comprise about 70% of the starch granule.

Mutants of different plants defective in certain enzymes are known as waxy mutants and give rise to starch granules having only amylopectin. Another enzyme, a debranching enzyme, most probably is involved in the synthesis of the starch granules and its polysaccharide components amylose and amylopectin.

Dispersal of a simpler and more linear form of starch, amylose, allows for greater mobility was can result in the molecules self-assembly into a more ordered structure. Aligning themselves parallel to each other, the hydrogen bonding that previously may have involved water, can be reduced to replaced by hydrogen bonding between the aligned chains. Ordering in this manner produces a three-dimensional network that constitutes an opaque gel. Otherwise referred to as retrogradation or set-back, only cooking and cooling can bring about the phenomenon, which occurs, generally, in this disclosure process.

Few medium-term studies have compared the weight loss potential of high and low GI high carbohydrate diets. Some studies (Marckmann et al, 2000, Slabber et al, 1994, Spieth et al, 2000), but not all (Jenkins et al, 1987), have shown more marked weight loss with a low GI diet vs. a high GI diet. This greater weight loss after a restrictive diet with a low GI could be linked to greater satiety and better use of fat reserves by enhanced fat oxidation at the expense of carbohydrate oxidation. One important issue is the action of low GI foods on modulation of the expression of human appetite and more specifically on satiation (within meals) and satiety (following meals). Several studies have shown that low GI meals or foods producing a low blood glucose response are more satiating than isoenergetic meals or high GI foods inducing high blood glucose (Brand-Miller et al, 2002, Ludwig, 2002). Because low GI starchy foods are characterized by a slower rate of digestion and absorption, nutrient receptors in the gastrointestinal tract are stimulated for a longer period of time, resulting in prolonged feedback to the satiety center in the brain (Lavin et al, 1998).

A further exciting prospect is the potential of GI foods to modulate oxidation and storage of fats. Post-prandial rises in glucose and insulin concentrations increase carbohydrate oxidation acutely through the rapid activation of key rate-limiting enzymes and reduce fat oxidation (Brand-Miller et al, 2002). High GI meals induce lower fatty acid plasma responses throughout the day (Kiens and Richter, 1996) and lower rates of fat oxidation than do low GI meals (Febbraio et al, 2000, Thomas et al, 1991). To date, emerging evidence exists to claim a beneficial effect of a high fiber low GI starchy diet on weight maintenance or weight loss. However, the limited availability of data requires further research including long-term clinical studies.

Flavoring Systems for Use with Meat Analogs

The disclosed meat-analog product can be flavored any time post final production, and especially anytime it is being prepared for the meal.

Starch, by virtue of its amylose content, is able to form inclusion complexes with many food ingredients such as essential oils, flavorings and fatty acids. It can thus act as an encapsulating agent, increasing the shelf life of the product, if desired.

The unique structure of this disclosure's final unflavored, neutral product encourages the addition of broths, brines, marinades, rubs and any other surface applied flavorings. It may subsequently be minimally microwaved (i.e. lowest power setting for mere seconds and minutes subject to quantities and weights) with those surface flavorings in order to better activate them for more rapid absorption. Thereafter they may be immediately eaten, fried, baked or broiled. The latter three high heat methods are recommended to have some oil mixed into the flavorings to avoid surface burning, as per any food that is subjected to a high heat source.

Existing meat analogs do not eliminate the detrimental environmental costs of consuming animal meats. A 2009 study by the Swedish Institute for Food and Biotechnology found that while producing a plate of peas requires a fraction of the energy needed to produce the same number of calories of pork, the energy costs of a pea-burger and a pork chop are about equal. Moreover defatting vegetable burgers imposes an environmental cost. The cheapest way to remove fatty soybean oil is with hexane, an EPA-registered air pollutant and suspected neurotoxin. A 2009 study by the Cornucopia Institute, a sustainable-farming nonprofit, found that Boca, Morningstar Farms, and Gardenburger (among others) market products were produced using hexane.

The present disclosure provides an economical, ecologically friendly method for providing a pleasing meat analog.

While the invention has been described with reference to preferred embodiments, those skilled in the art will understand that various changes may be made and equivalents may be substituted without departing from the scope of the invention. In addition, many modifications may be made to adapt a particular situation or material to the teachings of the invention without departing from its essential scope. It is intended that all matter contained in the above description or shown in the accompanying drawings be interpreted as illustrative and not in a limiting sense. Therefore, the invention is not to be limited to any particular embodiment disclosed as the best mode contemplated for carrying out this invention, rather the invention will include all embodiments falling within the scope of the appended claims. In this application all units are in the metric system and all amounts and percentages are by weight, unless otherwise expressly indicated. All citations referred herein are expressly incorporated herein by reference. Unless otherwise defined, all terms are considered to be defined according to Webster's New Twentieth Century Dictionary Unabridged Second edition.

We claim:

1. A method for preparing a meat analog comprising
a) combining a quantity of potato vegetable matter with an approximately equal weight of water;
b) homogenizing the potato and water combination to create a potato slurry with a generally uniform particle size;
c) heating the potato slurry to a uniform temperature of about 149° F.;
d) depositing the heated slurry into trays and cooling the slurry to under 40° F. to create a precooled paste;
e) freezing the pre cooled paste to a paste solid with a temperature of less than 0° F.;
f) thawing the paste solid to a paste slurry with a temperature of about 40° F., and pressing the paste slurry to obtain a fibrous pressed vegetable product with a final weight approximately equal to about the weight of the initial weight of potato vegetable matter;
g) refrigerating the pressed vegetable product for at least about 4 hours, tempering the product to allow even distribution of liquid in the pressed vegetable product;
h) placing the cooled, tempered in mixer at low speed, and adding approximately 50 weight parts of vital wheat gluten (VWG) to 100 weight parts of tempered pressed vegetable product, while continuing mixing at low speed to obtain uniform composition of gluten enriched vegetable product dough;
i) simmering the dough at about 200° F. with at least twice the volume of water for more than 1 hour, while restricting dehydration to create a meat analog;
j) cooling the meat analog, followed by slicing the meat analog into serving sized thicknesses, and simmering the meat analog servings in a excess volume of water for at least 30 minutes; and
k) draining the meat analog, cooling to approximately 38° F., and tempering the meat analog for more than about 4 hours,
whereby the final product is a meat analog with nutritional characteristics and physical texture approximates the nutrition and texture of a foodstuff created using primarily animal muscle tissue.

2. The method of claim 1 wherein the final simmering step is simmering the meat analog servings in a excess volume of water for at least 45 minutes.

3. The method of claim 1 wherein the final tempering step is cooling the analog to approximately 38° F., and tempering the meat analog for more than about 8 hours.

4. The method of claim 1 wherein the final tempering step further comprises the addition of flavors.

5. A meat analog produced according to the method of claim 1.

6. A meat analog produced according to the method of claim 2.

7. A meat analog produced according to the method of claim 3.

8. A method for producing a meat analog comprising a given weight of vegetable starches being heated in water at a range from approximately 60° to approximately 80° C., so that the vegetable starches to accept from about 10 to about 30 times the given weight of water to produce geletanized starch; said starches chilled and then frozen; following freezing the starch paste is then thawed and retrograded to begin severe syneresis, resulting in the formation of starch gel nodules; said starch gel nodules being pressed to remove water to a level of 4:1 to 6:1 parts water for each part of original dry flour weight of vegetable starch; mixing 100 weight parts said pressed gelatinized starch nodules with approximately 50 weight parts of vital wheat gluten to obtain uniform composition of gluten enriched vegetable product dough; simmering the dough at about 200° F. with at least twice the volume of water for more than 1 hour, while restricting dehydration to create a meat analog,
whereby the final product is a meat analog with nutritional characteristics and physical texture approximates the nutrition and texture of a foodstuff created using primarily animal muscle tissue.

9. The method of claim 8 further comprising vegetable starches that are derived from one or more of potato, rice, corn, cassava, and wheat.

10. The method of claim 9 further comprising vegetable starches that are derived from potato.

11. The method of claim 8 further comprising vegetable starches that are potato tubers.
